(19) United States
(12) Patent Application Publication
(10) Pub. No.: US 2018/0006938 A1
(43) Pub. Date: Jan. 4, 2018

(54) Application Domain Security

(71) Applicant: KnuEdge Incorporated, San Diego, CA (US)

(72) Inventors: Douglas B. Meyer, San Diego, CA (US); Michael George Creamer, San Diego, CA (US)

(21) Appl. No.: 15/200,976

(22) Filed: Jul. 1, 2016

(51) Int. Cl. H04L 12/741; H04L 29/06

(52) U.S. Cl. CPC H04L 45/74; H04L 69/22

(57) ABSTRACT

Methods, systems, and apparatus, including computer programs encoded on computer storage media, for application domain security. One of the methods includes maintaining, for each ingress port of a plurality of ingress ports of each top-level router of each processing device in a system, information representing one or more valid destination device ids for packets arriving at the ingress port. If an extracted destination device id of a packet received at a first ingress port of a first top-level router of a first processing device is an invalid destination device id according to information associated with the first internal ingress port, the first top-level router modifies a path of the received packet.

### BACKGROUND

This specification relates to the architecture of multiple-processor systems.

Some integrated circuits (ICs), or for brevity, chips, have multiple processing cores that communicate using an on-chip communications subsystem that routes packets to and from processing cores on the same chip or on other chips. This on-chip communications subsystem is commonly referred to as a network on a chip (NOC) to distinguish it from conventional bus or crossbar interconnections. An integrated circuit having a NOC communications subsystem can be referred to as a NOC processing device, or for brevity, a NOC device. Multiple NOC devices can be integrated into a single system so that all components of the multiple NOC devices are addressable using the same communications subsystem. Typically, the components of the system are all assigned addresses from a single address space. A system of multiple NOC devices that are integrated using a single, addressable communications subsystem will be referred to as a network on a chip complex (NOC complex).

Each chip in a NOC complex has one or more integrated routers that route packets received from processing cores on the same chip or from different chips. A packet received by a router can be routed to a processing core on the same chip from which it originated or to a different chip.

In such systems, reads and writes are handled by routing packets to packet-addressable memory blocks on chips in the complex. To write to a particular location in a particular packet-addressable memory block, a processing core can emit a write packet that causes a particular value to be written to a particular address of the memory block. The write packet contains a write opcode, a value, and an address.

To read from a particular location in a particular packet-addressable memory block, a processing core can emit a read packet that requests that a particular value stored at a particular address of the memory block be written to a particular address of another memory block (i.e., by emitting a subsequent write packet). Thus, a read packet typically has a payload that includes a write packet or information required to generate a write packet.

### SUMMARY

This specification describes techniques for improving application domain security in a system having multiple processing devices that execute multiple applications. The techniques below are described in terms of a system having multiple intercommunicating NM′, processing devices. However, the same techniques can also be implemented by any system having processing devices with integrated routers that route packets in an on-chip, packet-based communications subsystem.

In general, one innovative aspect of the subject matter described in this specification can be embodied in methods that include the actions of processing, by a plurality of to processing devices, packets originating from a plurality of different applications executing on one or more of the processing devices, wherein each processing device has one or more integrated processing cores and an integrated top-level router, wherein each processing device is assigned to exactly one application of the plurality of different applications, and wherein all processing devices assigned to a particular application belong to a corresponding application domain; maintaining, for each ingress port of a plurality of ingress ports of each top-level router of each processing device of the plurality of processing devices, information representing one or more valid destination device ids for packets arriving at the ingress port; receiving, by a first ingress port of a first top-level router of a first processing device, a packet; extracting a destination device id from the received packet; determining that the extracted destination device id of the received packet is an invalid destination device id according to information associated with the first ingress port; and in response to the determination, modifying, by the first top-level router, a path of the received packet. Other embodiments of this aspect include corresponding computer systems, apparatus, and computer programs recorded on one or more computer storage devices, each configured to perform the actions of the methods. For a system of one or more processing devices to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. Modifying the path of the received packet comprises dropping the packet without forwarding the packet to a device having the destination device id. Modifying the path of the received packet comprises routing the packet to a default port. The first ingress port is an internal ingress port, and wherein the packet originated from within the first processing device. The first ingress port is an external ingress port, and wherein the packet originated from a different second processing device. The information representing the one or more valid destination device ids comprises a first lookup table having information representing a plurality of valid destination device ids, and to wherein each top-level router of each processing device has a second main lookup table for routing packets arriving at ingress ports of the top-level router to egress ports of the top-level router. The top-level router has a main lookup table for routing packets arriving at the top-level router to a particular egress port of the top-level router; and wherein maintaining the information representing the one or more valid destination device ids for packets arriving at the ingress port comprises maintaining the information in the main lookup table. Each top-level router does not query the main lookup table for packets having invalid destination device ids according to the information associated with each ingress port. Each processing device has an on-chip, packet-based communications subsystem. The packet does not identify a source device from which the packet originated.

Another innovative aspect of the subject matter described in this specification can be embodied in methods that include the actions of processing, by a plurality of processing devices, packets originating from a plurality of different applications executing on one or more of the processing devices, wherein each processing device has one or more integrated processing cores and an integrated top-level router, wherein each processing device is assigned to exactly one application of the plurality of different applications, and wherein all processing devices assigned to a particular application belong to a corresponding application domain; maintaining, for each external egress port of a plurality of external egress ports of each top-level router of each processing device of the plurality of processing devices, information representing one or more valid destination device ids for packets arriving at the external egress port; receiving, by a first external egress port of a first top-level router of a first processing device, a packet; extracting a destination device id from the received packet; determining that the extracted destination device id of the received packet is an invalid destination device id according to information associated with the first external egress port; and in response to the determination, modifying, by the first top-level router, a path of the received packet. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. Modifying the path of the received packet comprises dropping the packet without forwarding the packet to a device having the to destination device id. Modifying the path of the received packet comprises routing the packet to a default port. The packet originated from within the first processing device. The packet has an invalid destination device id due to a hardware error within the top-level router. The packet is routed to an invalid egress port due to a configuration error. The information representing the one or more valid destination device ids comprises a first lookup table having information representing a plurality of valid destination device ids, and wherein each top-level router of each processing device has a second main lookup table for routing packets arriving at the top-level router. The top-level router has a main lookup table for routing packets arriving at the top-level router to a particular egress port of the top-level router, and wherein maintaining the information representing the one or more valid destination device ids for packets arriving at the external egress port comprises maintaining the information in the main lookup table. Each processing device has an on-chip, packet-based communications subsystem. The packet does not identify a source device from which the packet originated.

Particular embodiments of the subject matter described in this specification can be implemented so as to realize one or more of the following potential advantages. A system executing multiple applications can use destination-valid lookup tables to improve application domain security. The system can modify the routes of packets to eliminate snooping and corruption between applications from different application domains. In addition, the system can prevent denial-of-service style attacks on routers in a different application domain. The packet format does not need to be changed in order to identify invalid packets. Identifying the invalid packets does not have a significant impact on packet transit time. The identification of invalid packets can be performed in low-level hardware without software or firmware intervention, and thus applications themselves have no access to the configuration information.

Details of one or more embodiments of the subject matter of this specification are set forth in the accompanying drawings and the description below. Other features, aspects, and potential advantages of the subject matter will become apparent from the description, the drawings, and the claims.

### BRIEF DESCRIPTION OF THE DRAWINGS

FIG. 1 is a diagram of an example system.

FIG. 2 is a diagram of an example NOC device.

FIG. 3 illustrates the top-level router ports that are used for routing packets.

FIG. 4 is a diagram of an example system topology.

FIG. 5 is a flow chart of an example process for modifying routes of packets arriving at an ingress port of a top-level router of a NOC device.

FIG. 6 is a flow chart of an example process for modifying routes of packets arriving at an external egress port of a top-level router of a NOC device.

Like reference numbers and designations in the various drawings indicate like elements.

### DETAILED DESCRIPTION

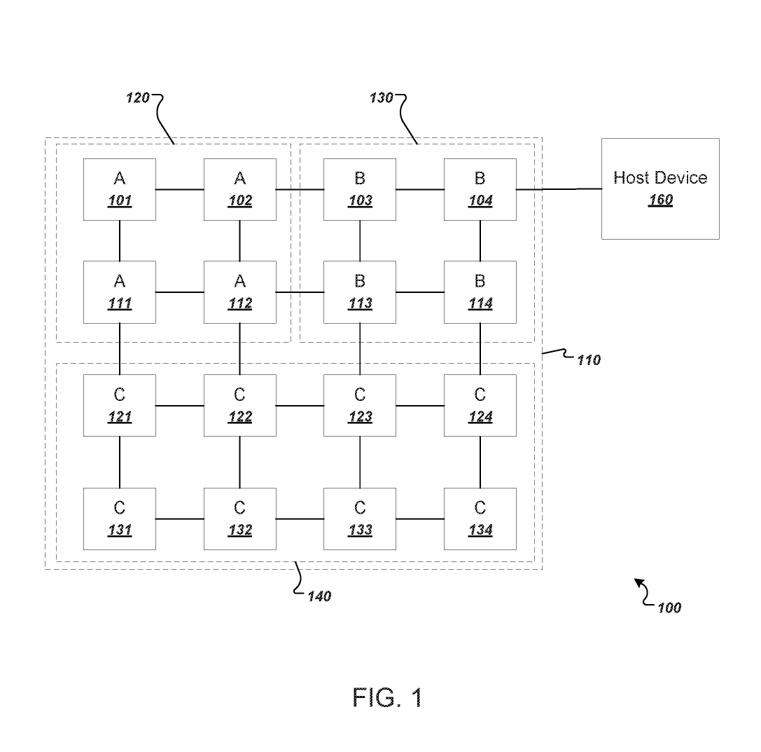

FIG. 1 is a diagram of an example system 100. The system 100 includes a host device 160 in communication with a NOC complex 110, or for brevity, a complex 110.

The host device 160 is any appropriate computing device that can provide for interaction with a user. For example, the host device 160 can be a laptop or desktop computer, a smart phone, a tablet computer, or any other appropriate device that includes one or more processors, computer readable media, and input and output devices for interaction with a user.

The complex 110 has sixteen NOC devices 101-104, 111-114, 121-124, and 131-134, which for brevity will be referred to as “chips,” The solid lines in FIG. 1 represent example wired connections between chips in the complex 110. Thus, the chips in the complex 110 are not fully interconnected. In other words, while the chip 101 can directly communicate packets to the chip 102, the chip 101 can only send packets to the chip 103 by routing the packets through one or more other chips, e.g., the chip 102.

Each NOC device can include a hierarchical arrangement of components, including a plurality of processing clusters, with each processing cluster having multiple processing cores. Thus, a NOC device may have any appropriate number of processing clusters, each with an appropriate number of processing cores, e.g., 4, 8, 32, 64, 128, or 256 processing cores.

The host device 160 can configure the complex 110 to run multiple applications. Each application has a respective application domain. The complex 110 implements to application domains so that an application having a particular application domain is assured that it will not suffer from interactions with other applications that belong to other application domains. In other words, one application belonging to one application domain cannot read from or write to destinations belonging to another application domain.

An application domain thus defines a mapping of system components in a complex to particular applications. Typically, each application is mapped to multiple components, but each component that is assigned to an application domain is mapped to exactly one application. Thus, in the example of FIG. 1, the application domain 120 for application “A” is defined to be the entire chips 101-102 and 111-112. The application domain 130 for application “B” is defined to be the entire chips 103-104 and 113-114. And the application domain 140 for application “C” is defined to be the entire chips 121-124 and 131-134.

The system can also assign application domains at finer levels of granularity. For example, the system can assign each processing cluster to a particular application domain. In that case, a single chip can have multiple application domains, but each processing cluster on the chip would belong to a single application domain. Similarly, the system can assign each processing core to a particular application domain. In that case, a single processing cluster can have multiple application domains, but each processing core in a cluster would belong to a single application domain.

For clarity, the techniques described below usually refer to application domains that are defined at the chip level. In other words, the system considers each chip to belong to a single application domain. However, the same techniques can also be used for application domains that are defined at finer levels of granularity.

In order for the complex 110 to run multiple applications, some components in one application domain may have to route packets that originated from another application domain. For example, in order for any of the chips in the application domain 140 to communicate with the host device 160, the packets originating in the application domain 140 will be routed through some chips belonging to the application domain 130 and possibly some chips belonging to the application domain 120.

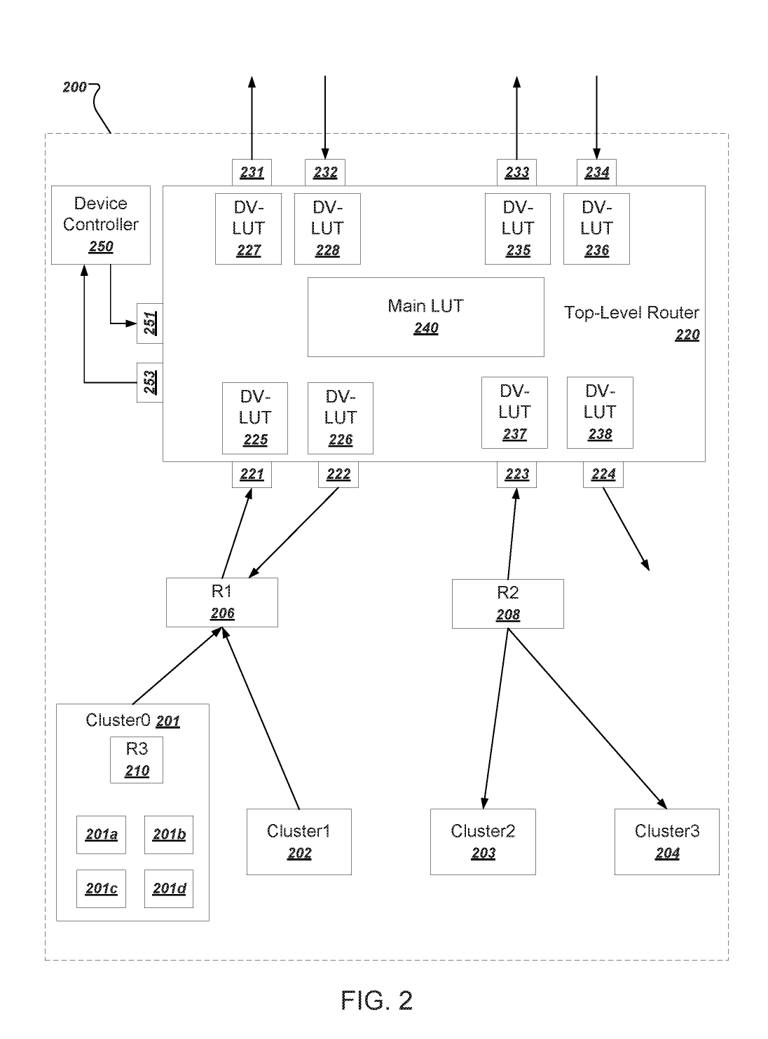

FIG. 2 is a diagram of an example NOC device 200. One or more components of the NOC device 200 receive packets, determine which packets are valid or invalid, route valid packets to their corresponding destinations, and modify the routes of invalid packets. The components illustrated in FIG. 2 can be manufactured as a single integrated circuit.

The NOC device 200 includes a plurality of processing clusters 201-204. Each cluster may have multiple processing cores. For example, the cluster0 201 has four processing cores 201a-d. Thus, the NOC device 200 may have 16 processing cores. A NOC device may have any appropriate number of processing cores, e.g., 32, 64, 128, or 256 processing cores.

The NOC device 200 also includes a top-level router 220 and may include intermediate routers, such as the two intermediate routers 206 and 208, and lower-level routers, such as the cluster-level router 210. The intermediate routers 206 and 208 may route packets between the top-level router 220 and the clusters 201-204, the processing cores within the clusters, or both. The cluster-level router 210 may route packets between the processing cores in the cluster 201 and intermediate routers 206 and 208 or between the processing cores in the cluster 201 and the top-level router 220, or both. Alternatively, the top-level router 220 may communicate directly with clusters 201-204, the processing cores within the clusters, or both.

For clarity, the example in FIG. 2 illustrates components of a top-level router 220 of NOC device 200, which can be used to implement chip-level application domains. However, the same or similar techniques can also be used in other lower-level routers to implement cluster-level or processing core-level application domains. For example, each intermediate router 206 and 208 or cluster-level router 210 can have the same or similar components as the top-level router 220.

The top-level router 220 may route packets within the NOC device 200. The top-level router 220 also receives packets that originate from outside the chip and also sends packets to destinations outside the chip.

To receive and route packets, the top-level router 220 uses internal and external ports. The top-level router 220 has external ports 231-234 and internal ports 221-224. Each internal or external port may operate as an ingress port or as an egress port, or the top-level router 220 may have separate ingress and egress ports. For example, the external egress port 231 and the external ingress port 232 can be implemented using the same hardware components or separate hardware components.

An internal ingress port is a port of a top-level router that receives packets from components within the same chip, e.g., from the intermediate router 206.

An internal egress port is a port of a top-level router that sends packets to components within the same chip.

An external ingress port is a port of a top-level router that receives packets from components not on the same chip, e.g., from another chip in the same complex.

Finally, an external egress port is a port of a top-level router that sends packets to components not on the same chip, e.g., to another chip in the same complex.

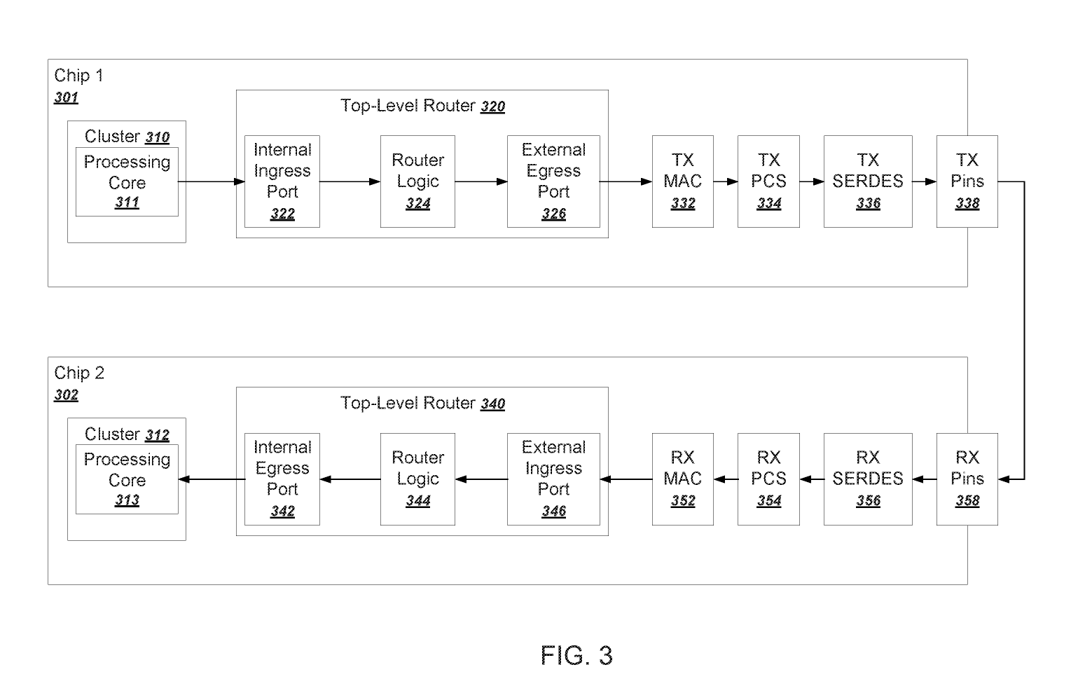

FIG. 3 illustrates the top-level router ports that are used for routing packets between two different chips. In this example, a first processing core 311 on a first chip 301 sends a packet to a second processing core 313 on a separate chip 302.

The first processing core 311 of a cluster 310 sends a packet to a top-level router 320 of the first chip 301, optionally via an intermediate router. Because the packet originates from within the same chip, the packet is received by the top-level router 320 at an internal ingress port 322. The top-level router 320 then uses router logic 324 to determine an external egress port 326 of the top-level router 320 out of which the packet will be sent.

The packet is then transformed though circuitry that implements one or more layers of a network protocol stack. For example, the packet may go through a TX MAC component 332 that performs operations of a media access control (MAC) layer, e.g., framing and adding an error correction code. A TX physical coding sublayer (PCS) component 334 may perform scrambling of the packet data to maintain the DC balance of the physical layer. And finally a TX serializer/deserializer (SERDES) component may convert the scrambled packet data into a serial bit stream signal.

TX Pins 338 on the first chip 301 are physically connected to RX pins 358 of the second chip 302. The connection carries the bit stream signal of the packet from the first chip 301 to the second chip 302.

The RX SERDES component 356 transforms the serial bit stream back into a scrambled data word, which is descrambled by the RX PCS component 354. The RX MAC component 352 can interpret the data payload from any framing added by the TX MAC component 332 and can check the error correction code. If there are no errors, the TX MAC component 332 can pass the payload corresponding to the original packet to the external ingress port 346.

The packet is received at an external ingress port 346 of a top-level router 340 of the second chip 302. The top-level router 340 uses its own router logic 344 to determine an internal egress port 342 out of which the packet will be sent. Finally, the packet is routed to a processing core 313 in a cluster 312 of the second chip 302, optionally via an intermediate router.

As shown in FIG. 2, the top-level router 220 is illustrated as having two internal ingress ports 221 and 223 that receive packets from components within the NOC device 200, two external egress ports 231 and 233 that send packets to components not on the NOC device 200, two internal egress ports 222 and 224 that send packets to components within the NOC device 200, and two external ingress ports 232 and 234 that receive packets from components not on the NOC device 200.

In general, each packet includes a header and a payload. The header includes an opcode and a destination device id. The content of the payload depends on the type of the packet, e.g., on whether the packet is a read packet or a write packet. For example, as described above, if the packet is a write packet, the opcode will indicate a write operation and the payload will include an address and an optional value to be written to the address.

The top-level router 220 uses the contents of the packet headers to determine how the packets should be routed. A packet header may include a destination device id, which can be used to identify the particular chip, cluster, and processing device to which the packet should be routed. For example, upon receiving a packet the top-level router 220 can inspect particular bits of the destination device id to determine to which internal egress port the packet should be sent out of. The top-level router 220 can for example examine a particular duster id within the packet header and determine that the cluster id is mapped to a particular internal egress port 222 corresponding to the intermediate router 206. Similarly, upon receiving a packet, the intermediate router 206 can determine that one or more bits of the packet header are mapped to the cluster 202. In some implementations, the headers of packets in a NOC complex have only destination device information and do not have source device information about the device from which the packet originated.

Example techniques for routing packets are described in commonly-owned U.S. patent application Ser. No. 15/077,772, for “Chained Packet Sequences in a Network on a Chip Architecture,” filed Mar. 22, 2016, and in commonly-owned U.S. patent application Ser. No. 15/143,215, for “Distributed Contiguous Reads in a Network on a Chip Architecture,” filed Apr. 29, 2016, which are both incorporated here by reference.

To route packets, the top-level router 220 can use a main lookup table (LUT) 240, which stores a mapping between destination device ids and internal egress ports, external egress ports, or both, of the top-level router 220. Thus, when the top-level router 220 receives a packet, the top-level router 220 can extract the destination device id and check the main LUT 240 for a match. If there is a matching egress port in the main LUT 240, the top-level router 220 can send the packet out of the corresponding egress port as indicated by the main LUT 240. If there is a miss, the top-level router 220 can use a default configuration, e.g., sending the packet out of a default egress port.

In order to improve application domain security within a complex, the top-level router 220 can also identify invalid packets and modify the routes of invalid packets. The top-level router 220 can identify packets as being invalid when the packets arrive at ingress ports, when the top-level router 220 is determining a route, or when the packet is being sent out of an egress port.

In this specification, an invalid packet is a packet having a destination device identifier for a device that belongs to an invalid application domain according to a topology of the system. Examples of system topologies that give rise to invalid packets are described in more detail below. The destination device identifier can correspond to a device at any appropriate granularity, e.g., to a chip, a cluster, or a processing core.

To determine whether or not a packet is valid or invalid, the top-level router 220 can use one or more per-port destination-valid lookup tables (DV-LUT), the main LUT 240, or both. For clarity these components are described as lookup tables, but each of the main lookup table and destination-valid lookup tables in the top-level router 220 can be implemented using any appropriate circuitry that receives a destination device id and generates a corresponding indication of valid or invalid. For example, the main lookup table, the destination-valid lookup tables, or both can be implemented using content-addressable memory (CAM), ternary CAM (TCAM), a lookup table (LUT), an address resolution table (ART), an hash table, an associative array, a database, or any appropriate circuitry that performs formula-based or pattern-based matching logic.

In this specification, modifying the route of an invalid packet means that a router does not allow an invalid packet to travel to a destination de vice indicated by a destination device id within the packet. Modifying the route of a packet can include dropping the packet entirely, routing the packet out of a different port, e.g., a default port, performing one or more error handling procedures, storing the packet in a log for later analysis, incrementing a dropped packet counter, or computing any other appropriate packet statistics.

As mentioned above, the top-level router 220 can identify invalid packets when the packets arrive at ingress ports, when determining routing for the packet, or when the packets leave at egress ports, or some appropriate combination of these.

To determine that a packet is invalid at an ingress port, the top-level router 220 can use a respective DV-LUT for one or more ingress ports. Thus, ingress ports 232, 234, 221, and 223 may have corresponding DV-LUTs 228, 236, 225, and 237. Each of the ingress DV-LUTs store information that represents valid destination device ids. Thus, each egress DV-LUT can store valid destination device ids, invalid destination device ids, or some combination of these. When a packet enters an ingress port, the top-level router 220 may check the corresponding DV-LUT for the ingress port to determine whether or not the destination device id of the packet is valid. If it is valid, the top-level router 220 can proceed to process the packet and route it to an appropriate destination. If it is not valid, the top-level router 220 may modifies the route of the packet, which can include dropping the packet entirely.

To determine that a packet is invalid during routing, the top-level router 220 can store validity information in the main LUT 240. Thus, for sonic destination device ids, the main LUT 240, instead of returning an egress port, can return an indication that the packet is valid or invalid.

To determine that a packet is invalid at an egress port, the top-level router 220 can use a respective DV-LUT for one or more egress ports. Thus, egress ports 231, 233, 222, and 224 may have corresponding DV-LUTs 227, 235, 226, and 238. Each of the egress DV-LUTs may store information that represents valid destination device ids. Thus, each egress DV-LUT may store valid destination device ids, invalid destination device ids, or sonic combination of these.

The egress DV-LUTs 227, 235, 226, and 238 may provide an extra layer of security that can protect against bits that might get flipped due to hardware errors during transmission within the top-level router 220 or during transmission between chips or due to configuration errors. For example, if a packet has a valid destination device id when it leaves a particular ingress port, e.g., ingress ports 221, 223, 232, or 234, the packet will be routed as normal and not filtered by the ingress port DV-LUTs, e.g., DV-LUTs 225, 237, 228, or 236. But if a bit is flipped in the destination device id of the packet during its transit to a corresponding egress port, the egress port DV-LUT, e.g. egress port DV-LUTs 226, 238, 227, or 235, for the corresponding egress port may re-evaluate the destination device id and catch the invalid destination device id. As another example, if the main LUT 240 is misconfigured such that an ingressing packet is routed to an incorrect egress port, the DV-LUT at the egress port may determine that the destination device id is not valid and may then take an appropriate action, e.g., by filtering the packet.

The main LUT 240 and each of the DV-LUTs can be configured by a device controller 250, which has its own ingress port 251 and egress port 253 into the top-level router 220. A host device communicates with the device controller 250 in order to configure the main LUT 240. In order to maintain a level of application domain security, the applications running in the complex should not be allowed to modify the main LUT or the DV-LUTs of the top-level routers. Thus, the configuration of these components should be performed by a privileged level of operation.

To configure the main LUT 240 and the DV-LUTs, secure software running on the host device can communicate with the device controller on a secure channel to exchange a secure key. Afterwards, the host-device can send, to the NOC device 200, configuration packets having the secure key and a destination device id corresponding to the device controller 250. The device controller 250 then verifies the configuration packet using the secure key and carries out the instructions in the packet, by writing information to the main LUT 240 or the DV-LUTs.

Thus, although not shown, typically the device controller ingress and egress ports 251 and 253 may also have their own DV-LUTs.

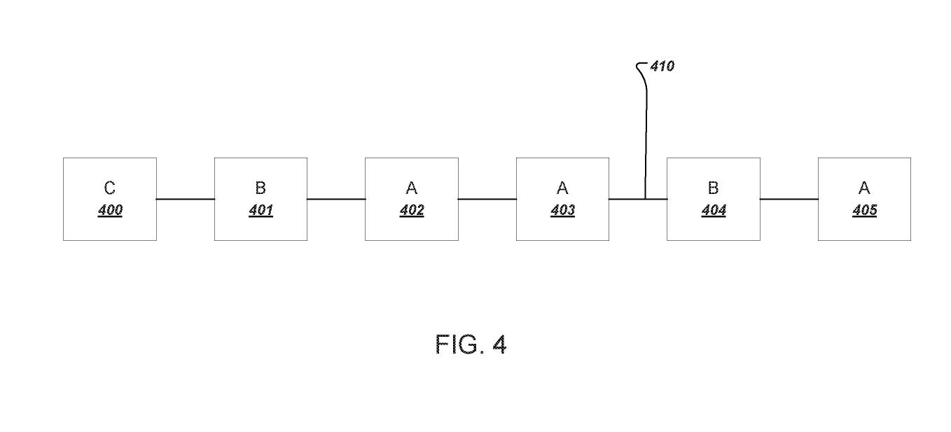

FIG. 4 is a diagram of an example system topology. The example topology includes six NOC devices 400-405. The topology of a NOC complex refers to which chips have a wired connection to other chips. The topology thus defines where chips can directly send packets over a wired connection.

In FIG. 4, the chip 400 has a connection with the chip 401. The chip 401 has a connection with the chips 400 and 402. The chip 402 has a connection with the chips 401 and 403. The chip 403 has a connection with the chips 402 and 404. The chip 404 has a connection with the chips 403 and 405. The chip 405 has a connection with the chip 404.

The six NOC devices 400-405 are assigned to three application domains. The first application domain for application “A” includes the chips 402, 403, and 405. The second application domain for application “B” includes the chips 401 and 404. The third application domain for application “C” includes the chip 400.

In this topology, the chip 405 must be allowed to communicate with the other chips 402 and 403 that are in the same application domain. Similarly, the chip 404 must be allowed to communicate with the chip 401 in the same application domain. However, the chip 400 has no valid reason for sending packets to any of the other chips.

A packet originating in the chip 404 has no valid reason for entering the chip 405. Therefore, the internal ingress ports of the chip 404 can have DV-LUTs that are configured to indicate that components in the chip 405 are not valid destinations for packets originating in the chip 404.

Thus, when a packet originating in the chip 404 has a destination device id of a component in the chip 405, the top-level router of the chip 404 can filter the packet at the internal egress port of the top-level router of the chip 404 before the packet exits the chip 404 at all and without querying the main LUT of the top-level router.

As another example, consider the link between the chip 401 and the chip 402. For this link, the external ingress port of the chip 402 can have DV-LUTs that are configured to indicate that components in the chip 403 are not valid destinations. Or equivalently, the external ingress DV-LUT can be configured to indicate that the only valid destinations for packets received on that link are components in the chips 401 and 404. Either way, when a packet addressed to the chip 403 is received at that ingress port, the packet will be filtered by the external ingress DV-LUT.

As another example, the external egress ports of the chip 401 can have DV-LUTs that are configured to indicate that components in the chip 400 are not valid destinations for any reason.

Thus, if a bit is flipped within the top-level router of the chip 401, a packet originating within the chip 401 and which is addressed to a device in the chip 400 will still be filtered by the DV-LUT for the external egress port of the chip 401.

The connection 410 between the chip 403 and the chip 404 will carry packets from both application domains for A and B. This means that a packet originating in the chip 404 will be allowed to enter the top-level router of the chip 403 for the purposes of being forwarded on to the chip 401. Therefore, the DV-LUTs of the chip 404 will indicate that components in the chip 401 are valid destinations for packets originating within the chip 404.

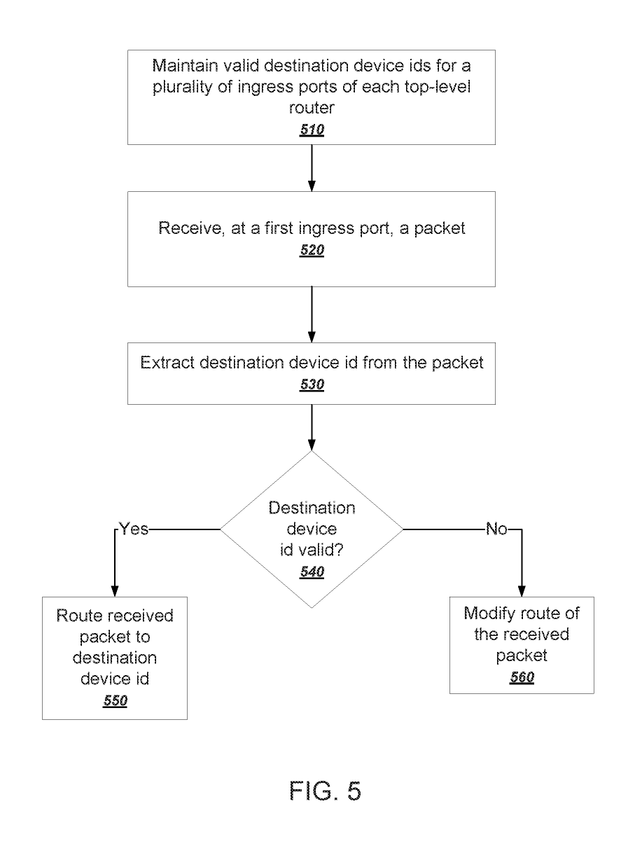

FIG. 5 is a flow chart of an example process for modifying routes of packets arriving at an ingress port of a top-level router of a NOC device. The example process can be performed by any appropriately configured logic circuitry or embedded computer. For convenience the process will be described as being performed by system having a top-level router, e.g., the top-level router 220 of FIG. 2.

The system maintains information representing valid destination device ids for each ingress port of each top-level router (510). As described above, a top-level router can have internal ingress ports and external ingress ports. The internal ingress ports receive packets that originate within the same chip, while the external ingress ports receive packets that originate elsewhere. Each ingress port can have a destination-valid lookup table for packets arriving at that internal ingress port. The DV-LUT maintains valid destination device ids, invalid destination device ids, or some combination of valid and invalid destination device ids.

The system receives, at a first ingress port, a packet (520). If the ingress port is an internal ingress port, the packet originated from within the device. If the ingress port is an external ingress port, the packet originated elsewhere (520).

The system extracts a destination device id from the packet (530). The system can for example use masking and bit shifting circuitry to extract the destination device id from the packet.

The system determines whether the device id is valid (540). To determine whether to the device id is valid, the system can consult the DV-LUT for the first ingress port.

Alternatively or in addition, the system can use the main LUT to filter packets. As described above, the main LUT maintains a mapping between destination device ids and external egress ports. To use the main LUT for ingress filtering, the main LUT can be augmented with information indicating whether particular destination device ids are valid or invalid. Thus, when the system receives a packet having a particular destination id, the system checks the main LUT to determine whether or not the destination device id is valid. If it is, the system can continue processing to obtain an external egress port for the packet.

If the destination device id is valid (540), the system routes the received packet using the destination device id (branch to 550). As described above, this may involve the system consulting a separate main lookup table to identify an external egress port for the packet. The system can then forward the packet out of the obtained external egress port. Other possible destinations include components within the chip, e.g., a device controller.

If the destination device id is not valid (540), the system modifies the route of the packet (560). As described above, the system can filter or drop the packet entirely or perform another error handling procedure. By dropping the packet, in some implementations the system need not consult the main lookup table at alt. This can prevent denial-of-service style attacks by an application in another application domain. In other words, by dropping packets at the ingress ports, the top-level router cannot become overwhelmed by querying the main LUT, which may be shared amongst some or all ports.

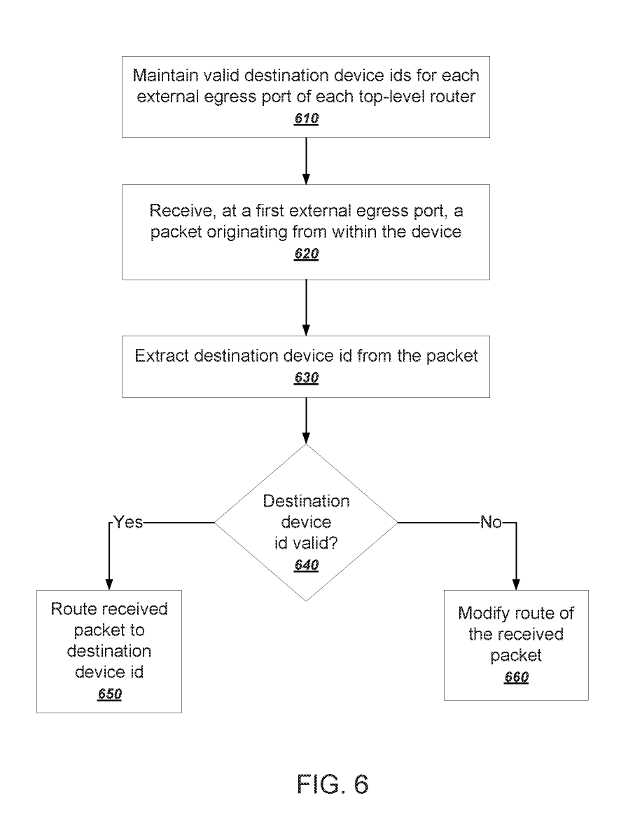

FIG. 6 is a flow chart of an example process for modifying routes of packets arriving at an external egress port of a top-level router of a NOC device. The example process can be performed by any appropriately configured logic circuitry or embedded computer. For convenience the process will be described as being performed by system having a top-level router, e.g., the top-level router 220 of FIG. 2.

The system maintains information representing valid destination device ids for each external egress port of each top-level router (610). As described above, a top-level router can have external egress ports that receive packets that originated within the chip and that have entered the top-level router. Each external egress port can have a destination-valid lookup table for packets arriving at that external egress port. The DV-LUT maintains valid destination device ids, invalid destination device ids, or some combination of valid and invalid destination device ids.

The system receives, at a first external egress port, a packet (620).

The system extracts a destination device id from the packet (630). The system can for example use masking and bit shifting circuitry to extract the destination device id from the packet.

The system determines whether the device id is valid (640). To determine whether the device id is valid, the system can consult the DV-LUT for the first external egress port.

If the destination device id is valid (640), the system routes the received packet using the destination device id (branch to 650). As described above, packets leaving the external egress port are routed to destinations outside the chip. Possible destinations include other chips in the system or a host device.

If the destination device id is not valid (640), the system modifies the route of the packet (660). As described above, the system can filter or drop the packet entirely or perform another error handling procedure.

In addition or as an alternative to the techniques described above, the system could implement packet filtering programmatically by processors executing software. For example, the top-level router of each chip can route each packet to a processor associated with the chip, e.g., a device controller associated with the chip. The processor associated with the chip could then decode the packet to determine whether or not has a valid destination. If the packet has a valid destination, the processor could route the packet out of an egress port or perform an error handling procedure otherwise, e.g., by dropping the packet.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
processing, by a plurality of processing devices, packets originating from a plurality of different applications executing on one or more of the processing devices, wherein each processing device has one or more integrated processing cores and an integrated top-level router, wherein each processing device is assigned to exactly one application of the plurality of different applications, and wherein all processing devices assigned to a particular application belong to a corresponding application domain;
maintaining, for each ingress port of a plurality of ingress ports of each top-level router of each processing device of the plurality of processing devices, information representing one or more valid destination device ids for packets arriving at the ingress port;
receiving, by a first ingress port of a first top-level router of a first processing device, a packet;
extracting a destination device id from the received packet;
determining that the extracted destination device id of the received packet is an invalid destination device id according to information associated with the first ingress port; and
in response to the determination, modifying, by the first top-level router, a path of the received packet.

2. The method of claim 1, wherein modifying the path of the received packet comprises dropping the packet without forwarding the packet to a device having the destination device id.

3. The method of claim 1, wherein modifying the path of the received packet comprises routing the packet to a default port.

4. The method of claim 1, wherein the first ingress port is an internal ingress port, and wherein the packet originated from within the first processing device.

5. The method of claim 1, wherein the first ingress port is an external ingress port, and wherein the packet originated from a different second processing device.

6. The method of claim 1, wherein the information representing the one or more valid destination device ids comprises a first lookup table having information representing a plurality of valid destination device ids, and wherein each top-level router of each processing device has a second main lookup table for routing packets arriving at ingress ports of the top-level router to egress ports of the top-level router.

7. The method of claim 1, wherein the top-level router has a main lookup table for routing packets arriving at the top-level router to a particular egress port of the top-level router, and wherein maintaining the information representing the one or more valid destination device ids for packets arriving at the ingress port comprises maintaining the information in the main lookup table.

8. The method of claim 7, wherein each top-level router does not query the main lookup table for packets having invalid destination device ids according to the information associated with each ingress port.

9. The method of claim 1, wherein each processing device has an on-chip, packet-based communications subsystem.

10. The method of claim 1, wherein the packet does not identify a source device from which the packet originated.

11. A computer-implemented method comprising:
processing, by a plurality of processing devices, packets originating from a plurality of different applications executing on one or more of the processing devices, wherein each processing device has one or more integrated processing cores and an integrated top-level router, wherein each processing device is assigned to exactly one application of the plurality of different applications, and wherein all processing devices assigned to a particular application belong to a corresponding application domain;
maintaining, for each external egress port of a plurality of external egress ports of each top-level router of each processing device of the plurality of processing devices, information representing one or more valid destination device ids for packets arriving at the external egress port;
receiving, by a first external egress port of a first top-level er of a first processing device, a packet;
extracting a destination device id from the received packet;
determining that the extracted destination device id of the received packet is an invalid destination device id according to information associated with the first external egress port; and
in response to the determination, modifying, by the first top-level router, a path of the received packet.

12. The method of claim 11, wherein modifying the path of the received packet comprises dropping the packet without forwarding the packet to a device having the destination device id.

13. The method of claim 11, wherein modifying the path of the received packet comprises routing the packet to a default port.

14. The method of claim 11, wherein the packet originated from within the first processing device.

15. The method of claim 11, wherein the packet has an invalid destination device id due to a hardware error within the top-level router.

16. The method of claim 11, wherein the packet is routed to an invalid egress port due to a configuration error.

17. The method of claim 11, wherein the information representing the one or more valid destination device ids comprises a first lookup table having information representing a plurality of valid destination device ids, and wherein each top-level router of each processing device has a second main lookup table for routing packets arriving at the top-level router.

18. The method of claim 11, wherein the top-level router has a main lookup table for routing packets arriving at the top-level router to a particular egress port of the top-level router, and wherein maintaining the information representing the one or more valid destination device ids for packets arriving at the external egress port comprises maintaining the information in the main lookup table.

19. The method of claim 11, wherein each processing device has an on-chip, packet-based communications subsystem.

20. The method of claim 11, wherein the packet does not identify a source device from which the packet originated.

21. A system comprising:
a plurality of processing devices, each processing device comprising one or more integrated processing cores and an integrated top-level router,
wherein each processing device is configured to receive an assignment to exactly one application of a plurality of different applications,
wherein each processing device of the plurality of processing devices is configured to perform operations comprising:
maintaining, for each ingress port of a plurality of ingress ports of the top-level router of the processing device, information representing one or more valid destination device ids for packets arriving at the ingress port, wherein the information represents an assignment of the plurality of processing devices to a plurality of different application domains,
receiving, by an ingress port of a top-level router of the processing device, a packet;
extracting a destination device id from the received packet;
determining that the extracted destination device id of the received packet is an invalid destination device id according to information associated with the ingress port; and
in response to the determination, modifying a path of the received packet.

22. The system of claim 21, wherein modifying the path of the received packet comprises dropping the packet without forwarding the packet to a device having the destination device id.

23. The system of claim 21, wherein modifying the path of the received packet comprises routing the packet to a default port.

24. The system of claim 21, wherein the ingress port is an internal ingress port configured to receive packets originating from within the processing device.

25. The system of claim 21, wherein the ingress port is an external ingress port configured to receive packets originating from a different processing device.

26. The system of claim 21, wherein the information representing the one or more valid destination device ids comprises a first lookup table having information representing a plurality of valid destination device ids, and wherein the top-level router of the processing device has a second main lookup table for routing packets arriving at ingress ports of the top-level router to egress ports of the top-level router.

27. The system of claim 21, wherein the top-level router has a main lookup table for routing packets arriving at the top-level router to a particular egress port of the top-level router, and wherein maintaining the information representing the one or more valid destination device ids for packets arriving at the ingress port comprises maintaining the information in the main lookup table.

28. The system of claim 27, wherein each top-level router does not query the main lookup table for packets having invalid destination device ids according to the information associated with each ingress port.

29. The system of claim 21, wherein each processing device has an on-chip, packet-based communications subsystem.

30. The system of claim 21, wherein the processing device is configured to process packets that do not identify a source device from which the packet originated.

31. A system comprising:
a plurality of processing devices, each processing device comprising one or more integrated processing cores and an integrated top-level router,
wherein each processing device is configured to receive an assignment to exactly one application of a plurality of different applications,
wherein each processing device of the plurality of processing devices is configured to perform operations comprising:
maintaining, for each external egress port of a plurality of external egress ports of the processing device, information representing one or more valid destination device ids for packets arriving at the external egress port, wherein the information represents an assignment of the plurality of processing devices to a plurality of different application domains;
receiving, by an external egress port of a top-level router of the processing device, a packet;
extracting a destination device id from the received packet;
determining that the extracted destination device id of the received packet is an invalid destination device id according to information associated with the external egress port; and
in response to the determination, modifying a path of the received packet.

32. The system of claim 31, wherein modifying the path of the received packet comprises dropping the packet without forwarding the packet to a device having the destination device id.

33. The system of claim 31, wherein modifying the path of the received packet comprises routing the packet to a default port.

34. The system of claim 31, wherein the external egress port is configured to filter packets originating from within the processing device.

35. The system of claim 31, wherein the external egress port is configured to filter packets having an invalid destination device id due to a hardware error within the top-level router.

36. The system of claim 31, wherein the external egress port is configured to filter packets routed to an invalid egress port due to a configuration error.

37. The system of claim 31, wherein the information representing the one or more valid destination device ids comprises a first lookup table having information representing a plurality of valid destination device ids, and wherein the top-level router of the processing device has a second main lookup table for routing packets arriving at the top-level router.

38. The system of claim 31, wherein the top-level router has a main lookup table for routing packets arriving at the top-level router to a particular egress port of the top-level router, and wherein maintaining the information representing the one or more valid destination device ids for packets arriving at the external egress port comprises maintaining the information in the main lookup table.

39. The system of claim 31, wherein each processing device has an on-chip, packet-based communications subsystem.

40. The system of claim 31, wherein the processing device is configured to process packets that do not identify a source device from which the packet originated.
